(19) United States
(12) Patent Application Publication
(10) Pub. No.: US 2008/0192233 A1
(43) Pub. Date: Aug. 14, 2008

(54) Near infrared electromagnetic radiation absorbing composition and method of use

(75) Inventor: Robert A. Rosania, Schwenksville, PA (US)

Correspondence Address: FLASTER/GREENBERG P.C.;8 PENN CENTER, 1628 JOHN F. KENNEDY BLVD., 15TH FLOOR, PHILADELPHIA, PA, 19103, US

(73) Assignee: Veil Corporation, Plymouth Meeting, PA (US)

(21) Appl. No.: 11/895,050

(22) Filed: Aug. 22, 2007

Related U.S. Application Data
(63) Continuation-in-part of application No. 10/892,820, filed on Jul. 16, 2004, now abandoned.
Application No. 10/892,820 is a division of application No. 09/641,745, filed on Aug. 18, 2000, now Pat. No. 6,794,431.

(51) Int. Cl. G01J 3/00; C08K 5/3437; C08L 33/06; C08K 5/23; C08K 5/32; C08K 5/34; F16F 15/00; G01N 21/55; C08K 5/08; C08K 5/357; C08K 5/1545; C08K 5/54

(52) U.S. Cl. 356/51; 524/89; 524/560; 524/190; 524/259; 524/88; 524/358; 524/96; 524/110; 524/261; 356/445; 181/207

(57) ABSTRACT

The present invention is directed to a liquid composition for coating surfaces. The composition includes an absorbing agent that attenuates reflection of radiation having a wavelength in the visible and NIR ranges. The coating further includes an acrylic homopolymer or copolymer carrier vehicle and a solvent system.

### CROSS-REFERENCE TO RELATED APPLICATIONS

This application is a Continuation-in-Part application of co-pending U.S. patent application Ser. No. 10/892,820 filed Jul. 16, 2004, which is a divisional application of U.S. patent application Ser. No. 09/641,745, filed on Aug. 18, 2000 now U.S. Pat. No. 6,794,431, the disclosures of which is incorporated by reference in its entirety.

### BACKGROUND OF THE INVENTION

1. Field of the Invention

This invention relates to a liquid composition for coating surfaces composed of a carrier vehicle, solvent system and an absorbing agent made from various chromophores, that attenuates visible and near infrared radiation.

2. Description of Related Art

Systems and devices, which use electromagnetic radiation in both the visible range (a wavelength of about 380 to about 750 nanometers) and the near infrared (NIR) range (a wavelength of about 750 to about 1400 nanometers) are well known and common to everyone. These systems and devices have a wide array of applications that include a scanning device at the local grocery store to national security and military equipment. Though the uses of these devices may vary, each is based on the absorption of electromagnetic radiation.

It is well known that the heat from electromagnetic radiation in the near infrared spectrum can have debilitating effects on many substrates. Damage and deterioration, such as cracking, can develop when a substrate is unprotected. This type of radiation can also cause damage to the eye. There are many sources of electromagnetic radiation in this range of the spectrum. The sun is a major source of near infrared electromagnetic radiation, however, other sources include tungsten filaments, fluorescent lamps, welding arcs, and laser light.

Compounds that absorb (NIR) electromagnetic radiation are also well known in the art. Aminium and diimmunonium salts are examples of such compounds and are described in U.S. Pat. Nos. 3,440,257 and 5,686,639, the contents of which are incorporated in relevant part herein by reference. These types of infrared absorbing compounds can be regarded as similar in that they strongly absorb energy in the NIR portion of the spectrum, yet they transmit light in the visible portion of the spectrum. Because of these properties, U.S. Pat. No. 3,440,257 teaches incorporating its NIR absorbing compounds into plastics for use in sunglasses, welding goggles, laser protection eyewear, and other products that shield the eye from the harmful effects of NIR radiation. These types of compounds can also be incorporated into other plastics to protect inanimate objects from hazardous NIR radiation, such as in projection lenses or television filters.

Wax and polish compositions have also been developed which contain compounds that absorb NIR radiation or other electromagnetic radiation, such as microwaves and radio waves. These waxes and polishes can be used to provide a protective layer to painted surfaces, such as automobile body parts, to attenuate the cracking and fading effects NIR radiation can have on such surfaces. Waxes and polishes containing visible and NIR radiation absorbing compounds have also been used for other purposes such as to defeat laser detection mechanisms by absorbing and diminishing the reflection of radiation.

However, waxes and polishes have drawbacks. Waxes and polishes often wash away easily after only short-term exposure to wet weather conditions. Most wax and polish compositions will provide an extremely thin coating which will often necessitate reapplication in order to provide greater absorbency. However, such reapplication of wax or polish coatings is usually not successful in achieving the necessary absorbency. Furthermore, polishes can be messy and waxes require rubbing and buffing, making application time consuming in most instances.

In addition to the problems discussed, most absorbing agents are limited in their ability and use based on the lack of a suitable carrier. In the past, carrier molecules have not existed which are able to be used with various absorbing agents, wherein the resulting liquid composition can be used in many different devices.

Thus, there exists a need in the art for a relatively inexpensive, easy to apply, weather-resistant, electromagnetic radiation absorbing coating composition which exhibits good absorbency of visible and NIR radiation and yet still transmits a substantial portion of visible light.

### BRIEF SUMMARY OF THE INVENTION

The present invention is directed to a liquid composition for coating surfaces including (a) an absorbing agent which attenuates electromagnetic radiation in the visible and/or near infrared wavelength ranges; (b) a carrier vehicle, wherein the carrier vehicle comprises a polymer selected from the group consisting of a copolymer having at least butyl acrylate, methylmethacrylate and hydroxyethylmethacrylate as monomers or a copolymer having at least methylmethacrylate, ethylacrylate and dimethylaminoethylmethacrylate as monomers and a solvent system.

The absorbing agent comprises dyes derived from the following chromophore groups: acridine, anthraquinone, diphenyl methane, triphenyl methane, azo structure, diazonium salts, a nitro functional group, nitroso functional group, phthalocyanine, quinone, safranin, indamins, indophenol, oxazin, oxazone, thiazin, thiazole, xanthene, fluorene, rhodamine and fluorone.

The present invention also relates to a method of reducing the reflection of visible and/or near infrared radiation from a surface. The method includes applying a liquid composition including an absorbing agent, which attenuates electromagnetic radiation in the visible and near infrared wavelength ranges, a carrier vehicle and a solvent system to a surface. The solvent system is removed after application of the composition to a surface.

In another embodiment, the invention includes a system for detecting an object. The system includes an object having a near infrared composition disposed thereon, wherein the composition attenuates near infrared radiation at a wavelength of about 750 to about 1100 nanometers. The system further includes a detecting device that detects near infrared radiation at a wavelength of about 750 to about 1100 nanometers.

In yet another embodiment, the invention includes a detector assembly for creating a scanner signal in response to light reflected from a scan pattern by a bar code, the scan pattern consisting of light having a defined wavelength. The detector assembly includes a light sensitive detector, operative to generate a signal in response to light striking the detector, and a composition applied on a portion of the light sensitive detector. The composition includes an absorbing agent that attenuates reflection of electromagnetic radiation, a solvent system and a carrier vehicle.

In yet another embodiment, the invention includes a tape to attenuate reflection of visible and near infrared radiation to a detector. The tape has a first side with a coating applied thereto. The coating attenuates reflection of visible and near infrared radiation at a wavelength of about 500 nanometers to about 1100 nanometers. The coating includes a near infrared absorbing agent, solvent system and carrier vehicle. A second side of the tape is for adhering to a surface.

In yet another embodiment, the invention includes a method to attenuate the detection of sound, by a laser microphone, based on vibration of specific surfaces within a closed room. The method includes applying a coating to a surface within a closed room, having a window for the access of the laser, which will vibrate upon contact with sound waves. The coating includes an absorbing agent which attenuates reflection of radiation having a wavelength of about 500 nanometers to about 1100 nanometers, a carrier vehicle and a solvent system. The room is subjected to sound waves which cause vibration to the coated surfaces upon contact with sound waves.

In yet another embodiment, the invention includes a method of producing a liquid composition that attenuates reflection of visible and/or near infrared radiation. The method including the steps of combining an absorbing agent that attenuates visible and near infrared radiation at a wavelength of about 380 nanometers to about 1400 nanometers and a carrier vehicle. The method further comprises adding a solvent solution to the combination of the near infrared absorbing agent and the carrier vehicle.

### BRIEF DESCRIPTION OF THE SEVERAL VIEWS OF THE DRAWING(S)

The foregoing summary, as well as the following detailed description of preferred embodiments of the invention, will be better understood when read in conjunction with the appended drawings. For the purpose of illustrating the invention, there is shown in the drawings embodiments which are presently preferred. It should be understood, however, that the invention is not limited to the precise arrangements and instrumentalities shown. In the drawings:

FIG. 1 is a graphical representation of the absorbance (A) of the coating prepared using the liquid composition of Example 7, measured at several different wavelengths, both upon initial coating and two months later;

FIG. 2 is a graphical representation of the absorbance (A) of the coating prepared using the liquid composition of Example 8, measured at several different wavelengths, both upon initial coating and two months later;

FIG. 3 is a graphical representation of the absorbance (A) of the coating prepared using the liquid composition of Example 9, measured at several different wavelengths, both upon initial coating and two months later;

FIG. 4 is a graphical representation of the absorbance (A) of the coating prepared using the liquid composition of Example 10, measured at several different wavelengths, both upon initial coating and two months later; and

FIG. 5 is a graphical representation of the absorbance (A) of the coating prepared using the liquid composition of Example 11, measured at several different wavelengths, both upon initial coating and two months later.

### DETAILED DESCRIPTION OF THE INVENTION

The present invention includes a liquid composition for coating surfaces comprising an absorbing agent which attenuates reflection of electromagnetic radiation having a wavelength in the visible or near infrared ranges, a carrier vehicle and a solvent system.

The absorbing agent can be any compound capable of absorbing electromagnetic radiation with a wavelength of about 380 nanometers to about 1400 nanometers. The absorbing agent should also preferably transmit a large portion of light in the visible spectrum. Such compounds are well known in the art and commercially available, e.g. Epolin, Inc. of Newark, N.J.

The absorbing agents can be made from a variety of dyes from chromophores derived from the following chromophore groups: acridine, anthraquinone, diphenyl methane, triphenyl methane, azo structure, diazonium salts, a nitro functional group, nitroso functional group, phthalocyanine, quinone, safranin indamins, indophenol, oxazin, oxazone, thiazin, thiazole, xanthene, fluorene, rhodamine and fluorone and derivatives and combinations thereof. These dyes define the wavelength of the absorbing agents based on their preference of absorbence in specific wavelengths. The wavelengths span both the visible and near infrared spectrum of electromagnetic radiation.

In addition, diimmonium and aminium salts can be used. Exemplary diimmonium salts of the general formula (I) can be used as the absorbing agent of the present invention:

[(R₂NZ)₂N══Z′══NR₂]²⁺+2X⁻ (I)

wherein R may be an alkyl group of about 1 to about 6 carbon atoms; Z is preferably an unsubstituted divalent phenyl or a divalent phenyl substituted with one or more moieties such as alkyl, alkoxy, halogen, nitro, cyano, and/or carboalkoxy groups; Z′ is preferably an unsubstituted quinoidal phenyl or a quinoidal phenyl substituted with at least one of the following moieties: alkyl, alkoxy, halogen, nitro, cyano, and/or carboalkoxy groups; and X may be, for example, an anion of a strong acid.

Suitable aminium salts of the general formula (II) can be used as the near infrared absorbing agent of the present invention:

[(R₂NZ)₃N]⁺+X⁻ (II)

wherein R is preferably an alkyl group of about 1 to about 6 carbon atoms; Z may be an unsubstituted divalent phenyl or a divalent phenyl substituted with one or more moieties such as alkyl, alkoxy, halogen, nitro, cyano, and/or carboalkoxy groups; and X may be, for example, an anion of a strong acid.

Examples of anions of strong acids which could be used as X⁻ above in either formula (I) or (II) include perchlorate (ClO₄⁺), tetrafluoroborate (BF₄⁺), trichloroacetate (CCl₃CCO⁻), trifluoroacetate (CF₃COO⁻), picrate ((NO₂)₃C₆H₂O⁻), hexafluoroaluminate (AlF₆⁻), hexafluorosilicate (SiF₆⁻), hexafluoroarsenate (AsF₆—), hexachloroantimonate (SbCl₆⁻), hexafluoroantimonate (SbF₆⁻), benzenesulfonate (C₆H₅SO₃⁻), alkyl sulfonate (RSO³⁻) the alkyl group thereof containing 1 to about 18 carbon atoms, hexafluorophosphate (PF₆—), phosphate (PO₄³⁻), sulfate (SO₄²⁻), chloride (Cl⁻) or bromide (Br⁻). Hexafluoroantimonate (SbF₆⁻) and hexafluoroarsenate (AsF₆⁻) are also known for their heat resistance and may be used in the present invention.

The preferred absorbing agents of the present invention are N,N-dialkyl-N′,N′-bis(p-dialkylaminophenyl)benzoquinone diimmonium salts of tetrafluoroborate, hexafluoroantimonate, hexafluorophosphate, hexafluoroaluminate, hexafluorosilicate, hexafluoroarsenate, and perchlorate. Examples of such are N,N-di-n-butyl-N′,N′-bis(p-di-n-butylaminophenyl)benzoquinone diimmonium hexafluoroantimonate, N,N-diethyl-N′,N′-bis(p-diethylaminophenyl)benzoquinone diimmonium hexafluoroantimonate, and N,N-diethyl-N′,N′-bis(p-diethylaminophenyl)benzoquinone diimmonium hexafluorophosphate. Near infrared absorbing agents of these types are described in U.S. Pat. No. 3,440,257 and U.S. Pat. No. 5,686,639, the contents of each are herein incorporated by reference. In addition, absorbing agents prepared from carbon and graphite material are also within the scope of the invention.

A liquid composition for coating surfaces in accordance with the present invention includes an absorbing agent present in an amount of about 0.01% to about 2% by weight, a carrier vehicle present in an amount of about 20% to about 60% by weight, and a solvent system present in an amount of about 40% to about 80% by weight, each based upon the total weight of the composition.

In a preferred embodiment of the invention, the liquid composition comprises an absorbing agent present in an amount, based upon total weight of the composition, of about 0.1% to about 2% by weight, a carrier vehicle present in an amount of about 30% to about 45% by weight, and a solvent system present in an amount of about 55% to about 70% by weight. In a most preferred embodiment of the invention, the liquid composition includes an absorbing agent present in an amount, based upon the total weight of the composition, of about 0.25% to about 0.75% by weight, a carrier vehicle present in an amount of about 30% to about 40% by weight, and a solvent system present in an amount of about 60% to about 70% by weight.

The carrier vehicles of the compositions of the present invention can be a homopolymer, a copolymer, an oligomer, a terpolymer, or mixtures thereof. Polymers which may be used include, but are not limited to, celluloses, polyacrylics including acrylic polymers, methylacrylic polymers, acrylate and methacrylate polymers, polyurethanes, polyesters, polyvinyls, polyamides, and polyolefins such as polyethylene and polypropylene, and derivatives and mixtures thereof. The polymers which may be used may be either water-borne or solvent-borne.

Preferably, the carrier vehicle is an acrylic homopolymer or copolymer with carboxyl and hydroxyl functionality. The acrylic homopolymer or copolymer can be water-soluble, or at least miscible with water to some degree. The acrylic homopolymers or copolymers of the present invention having any degree of water-solubility, whether completely miscible, or only partly miscible with water, are referred to herein as water-borne acrylic polymers. The preferred water-borne acrylic polymer is a copolymer having an acid number of about 0 to about 50, preferably about 20 to about 45, and most preferably about 30 to about 40; and having a hydroxyl number of about 15 to about 50, and more preferably about 20 to about 50.

The molecular weights of the preferred water-borne acrylic polymers of the present invention preferably range about 20,000 g/mol to about 40,000 g/mol, and more preferably about 25,000 g/mol to about 35,000 g/mol. The water-borne acrylic polymers also preferably have a solids content of about 45% to about 55% by weight, the remainder being anyone or more of water, other solvents, surfactants and impurities.

A preferred water-borne acrylic polymer of the present invention is a copolymer polymerized from monomers including butyl acrylate, methylmethacrylate, hydroxyethylmethacrylate, methacrylic acid, and acrylic acid. In such a copolymer, butyl acrylate may be present in an amount of about 45% to about 55% by weight, preferably in an amount of about 49% to about 52% by weight, and more preferably in an amount of about 49% to about 50% by weight, based upon the total weight of the copolymer.

Methyl methacrylate can be present in an amount of about 38% to about 45% by weight, preferably in an amount of about 40% to about 45% by weight, and more preferably in an amount of about 42% to about 45% by weight, based upon the total weight of the copolymer.

Hydroxylethylmethacrylate can be present in an amount of about 4% to about 10% by weight, and preferably in an amount of about 4% to about 6% by weight, based upon the total weight of the copolymer.

Methacrylic acid can be present in an amount of about 0% to about 8% by weight, preferably in an amount of about 0% to about 5% by weight, and more preferably in an amount of about 0% to about 3% by weight, based upon the total weight of the copolymer. Acrylic acid can be present in an amount of about 0% to about 2% by weight, based upon the total weight of the copolymer.

Alternatively, another preferred water-borne acrylic polymer of the present invention is a copolymer polymerized from monomers including methylmethacrylate, ethylacrylate and dimethylaminoethylmetacrylate. In such a copolymer, methylmethacrylate may be present in an amount of about 40% to about 70% by weight, based upon the total weight of the copolymer. Ethylacrylate may be present in an amount of about 10% to about 30% by weight, based upon the total weight of the copolymer. Dimethylaminoethylmetacrylate may be present in an amount of about 20% to about 30% by weight, based upon the total weight of the copolymer.

The polymers are preferably formed by any suitable polymerization procedure including random, block or graft polymerization. Most preferably the copolymer is formed by a continuous addition process conducted over a time period of about 1.5 to about 2 hours at a temperature of about 82-84° C. at atmospheric pressure, in the presence of a nitrile catalyst. The catalyst is preferably a 2,2′-azobis-(2-alkyl)butyronitrile compound, such as, for example 2, 2′ azobis (2-methyl)butyronitrile or 2,2′ azobis (2-ethyl)butyronitrile. The polymerization is preferably carried out in a secondary alcohol medium, such as, for example, an isopropanol medium. However, it will be understood, based on the disclosure, that other suitable water-borne polymers or polymerization procedures could be used without departing from the scope of the present invention.

The carrier vehicle of the present invention may also be a mixture of more types of polymer. For example, a polyurethane and an acrylic polymer mixture could be used as the carrier vehicle in the present invention. Shellac may also be used alone or in combination for a carrier vehicle.

The carrier vehicle of the present invention may also be an organic solvent borne polymer having a solids content of about 40% to about 50% by weight, and preferably about 45% by weight. Such solvent-based polymer formulations are generally known to those of ordinary skill in the art for other purposes. One example of a preferred solvent-borne polymer useful as a carrier vehicle in the present invention is the acrylic copolymer Acryloid® B67, available from Rohm & Haas Co., Inc., of Philadelphia, Pa. (also available under the name Paraloid.

In situations where the environment is of particular concern, water-borne carrier vehicles that contain little or no volatile organic solvents are preferred. Solvent systems useful in the present invention should include one or more individual solvent components which are each compatible with both the absorbing agent and the carrier vehicle and should be co-miscible with each other. Therefore, a solvent system which may be used in the present invention may include one or more solvent components depending on the selection of the particular absorbing agent and carrier vehicle for compatibility purposes. Ketones, such as acetone and methylethylketone, are preferred for use in the solvent system as components for dissolving diimmonium salts, although any organic solvent capable of dissolving the absorbing agents of the present invention, which is also compatible with the carrier vehicle, can be used. Solvents system components which are preferably incorporated into the solvent system of the present invention when a solvent-borne carrier vehicle is selected include, but are not limited to, alcohols, ketones, naphtha and naphtha derivatives, and other known organic solvents having similar solubility properties and which are compatible with substantially hydrophobic solutes.

The solvent components which are preferably incorporated into the solvent system of the present invention, when a water-borne carrier vehicle is selected, include, but are not limited to, alcohols (such as ethanol, propanol, butanol, isopropanol, sec-propanol, t-butanol, etc.), ketones, terpenes, glycol ethers, water and mixtures thereof terpenes and other citrus-based solvents including d-limonene may be used. Horizon® EP, a solvent available from Inland Technology, Inc., of Tacoma, Wash., may be used in the solvent system according to the present invention.

Other solvents such as citrus-based solvents and glycol ethers, including for example, Cellosolve® ethers and other propylene glycol ethers, can also be incorporated, alone or in combination with other solvent components such as ketones, into the solvent system of the present invention.

Another factor which is preferably considered in selecting the solvent system of the present invention is evaporation rate. The solvent component, or components, of the solvent system should evaporate, at room temperature, at a rate quick enough to allow for ease of application and quick drying of the coating on a surface, yet slow enough to maintain a uniform and level coating upon drying. Evaporation should therefore be as quick as possible, provided an even coating can be maintained. Lower molecular weight solvents such as one or more of the propanol isomers (e.g., n-, iso-, sec-) and/or acetone are preferable for this reason. Butanol isomers (e.g., n-, iso-, sec-, tert-) can also be used, but are slower to evaporate than propanol(s), somewhat inhibiting easy coating of a surface. This becomes more significant when coating a vertical surface due to the effects of gravity on coating thickness and uniformity, and in order to prevent sagging.

In order to enhance the adherence and water-resistance properties of the liquid compositions of the present invention, such compositions may optionally include one or more organofunctional silane additives selected from the group consisting of amino functional silanes, glycidoxy(epoxy) functional silanes and vinylfunctional silanes. Preferred organofunctional silane additive(s) include the glycidoxy(epoxy) functional silane 3-glycidoxypropyltrimethoxysilane, available as Dow Corning® Z-6040 Silane, and the vinylfunctional silane vinyltrimethoxy silane, available as Dow Corning® 9-6300, both from Dow Corning Corporation, Midland, Mich. The one or more organofunctional silane additive(s) may be present in the liquid composition, an amount of about 0.01% to about 2% by weight. If the one or more silane additives chosen is a glycidoxy(epoxy) functional silane, it is preferably present in the liquid composition in an amount of about 0.1% to 0.5% by weight, more preferably in an amount of about 0.2% to about 0.35% by weight. In the case that the one or more organofunctional silane additive is a vinylfunctional silane, it is preferably present in an amount of about 0.01% to about 2% by weight, more preferably in an amount of about 0.04% to about 0.09% by weight.

Further, the liquid compositions of the present invention may optionally include any number of additional preferred additives such as ultraviolet absorber(s), flatting agent(s), slip agent(s), pH modifier(s) and colorant(s).

Exposure to ultraviolet radiation can increase the rate of chemical degradation of the absorbing agent and limit its capability to absorb light. Common UV absorbers which can be used in accordance with the present invention include hydroxybenzophenones, hydroxyphenyl benzotriazoles, cinnamates, and oxanilides. In fact, any compound which is capable of absorbing ultraviolet light and which does not substantially affect the absorbing agent's capacity to absorb radiation can be added to the composition. The UV absorbing compound may be added in an amount up to about 2% by weight, and preferably about 0.5% to about 2% by weight. Cyasorb® UV-24 and Cyasorb® UV-5411, both available commercially from Cytec Industries, Inc., of West Patterson, N.J., are examples of such compositions.

It is preferred that reflection of visible and near infrared radiation, and glare in general, from the surface coated with the composition of the invention be minimized. This can be accomplished by the addition of one or more flatting agents to the liquid compositions of the invention. Silica is an example of such a flatting agent. Other flatting agents that can be used in the compositions of the invention include heavy metal soaps (i.e., soaps formed with metals heavier than sodium), diatomaceous earth, flatting urea derivatives, and the like.

The compositions of the present invention may also include one or more slip agents. Slip agents, such as silicone-based materials, fluoropolymer powders, graphite, fatty acid esters, hydrocarbon waxes, etc., may be added to provide certain water-resistant properties to the coatings. While normally intended to provide lubricating properties, slip agents which are hydrophobic in nature may help to enhance the weather resistant properties of the liquid compositions and resulting coatings.

The compositions of the present invention may also include one or more pH modifiers. For example, ammonia and/or other basic compounds, such as, for example, amines, may be added to raise the pH of the composition. Certain absorbing agents may produce acidic liquid compositions, and pH modifiers can be added to neutralize the compositions.

Additionally, depending on the specific absorbing agent used, the liquid compositions of the invention, once applied to a surface, may exhibit a slight tint which could be undesirable in some applications. In such cases, it is preferable to include one or more colorants to color balance the coating composition, thereby producing a neutral or gray tint in the resulting coating.

Various flow and leveling modifiers, fillers, thickeners, and thixotropic modifiers may be added to the compositions of the invention to impart specific desired application properties. However, it will be understood that other additives which do not affect the absorbing properties, the uniform coating properties, or the compatibility and/or miscibility of the components of the compositions of the present invention can be added to modify properties as desired

A coating applied in accordance with the method of the present invention generally has a thickness of about 0.25 mil to about 2 mil. Preferably the coating is about 0.5 mils to about 1.5 mils in thickness, and is most preferably about 0.5 mils to about 1.0 mils. Such coating thicknesses are greater than that of polishes and waxes and provide increased absorbency and increased durability.

Coatings including absorbing agents of diimmonium and ammonium salts, discussed herein, and applied in accordance with the method of the present invention, are capable of absorbing greater than about 99% of radiation with wavelength of about 885-920 nanometers incident upon the coating, depending on the particular absorbing agent selected. The portion of light within the visible spectrum that is transmitted is about 75% or more, and preferably about 85% or more.

The present invention also relates to a method of reducing the reflection of electromagnetic radiation from a surface. The method includes applying a liquid composition, as described in accordance with the present invention, to a surface. The solvent system is removed preferably after application of the composition to a surface by evaporation in ambient conditions, but could be removed with the aid of reduced pressure, heat or other methods by which drying rates can be increased.

The compositions of the present invention can be applied to surfaces in the same manner as a paint or varnish, e.g., brush, roller, spray, or similar methods of application. After such application the solvent system is removed, for example, by room temperature evaporation. It is possible to augment or enhance the removal of the solvent system, by heating or decreasing pressure, so long as the uniformity of the coating is not impaired.

In another embodiment, the invention includes a system for detecting an object having a near infrared absorbing composition of the present invention disposed thereon. In this embodiment, the composition is described as a near infrared absorbing composition because it includes an absorbing agent which absorbs radiation only in the near infrared region. The system includes an object, having the near infrared composition disposed thereon, wherein the composition attenuates near infrared radiation at a wavelength of about 904 nanometers and a detecting device which detects near infrared radiation at a wavelength of about 904 nanometers. The detection device is most commonly a Light Distance And Ranging “gun” (LIDAR) emitting a wavelength in the defined range. This system is further explained in U.S. Pat. No. 6,794,431.

As illustrated in Example 1, the object can be a vehicle having the composition applied to the glass and metal surfaces, at a thickness of about 0.7 millimeters. As defined in Table 1, detection was decreased by at least 20% in comparison to an objects which did not have the composition applied thereto.

In another embodiment, the invention includes a detector assembly for creating a scanner signal in response to light reflected from a scan pattern of a bar code, the scan pattern consisting of light having a defined wavelength. These types of detectors are known and discussed in U.S. Pat. No. 6,752,315, incorporated herein in relevant part. The detector assembly includes a light sensitive detector operative to generate a signal in response to light striking the detector, a lens element integral with the detector, and the coating of the present invention on a portion of the light sensitive detector. Most commonly, the coating is applied to the lens element. Conversely, the coating can be applied to the “bar coding” of an identification badge to eliminate detection, thereby ensuring the protection of identity in security or military uses. The detector senses incident light strike having a wavelength of about 670 nanometers. The detector assembly includes an integral lens element which may include a capsule to focus light onto the detector.

In a further embodiment, the invention includes a tape to attenuate reflection of visible and near infrared radiation from a detector. The tape having a first side with a coating thereon which absorbs incident radiation and a second side for adhering to a surface. The coating attenuates reflection of visible and near infrared light having a wavelength within a range defined by the absorbing agent of the present invention.

Various types of material exist for the tape and an “adhesive” or “backing”, which are known in the art as discussed in U.S. Pat. No. 6,485,589, incorporated herein in relevant part. The tape can be of any suitable material that can be used with a coating. Moreover, production of a film based on the composition of the present invention which includes an adhesive backing, for application to a surface, is within the concept of this embodiment. In addition, the tape can include a housing or edging material, such as carbon black. The edging material prevents undesired light from being transmitted to a detecting means. The coating on the first side of the tape has thickness of about 6.0 to about 40 mils.

In a further embodiment, the invention includes a method to attenuate the detection of sound by a laser microphone within a closed room, having at least one window for access from the outside. Laser microphone technology is well known in the art and discussed in U.S. Pat. Nos. 6,147,787, 4,479,265 and 4,412,105, incorporated herein in relevant part. The method includes applying a liquid composition or coating, as defined by the present invention, to any surface within a closed room that will vibrate upon contact with sound waves. Application of the liquid composition or coating can be achieved by various methods including a tape (as described herein), spray formulation or brushing. Thereafter, the closed room is subjected to sound waves, such as talking, so that the sound waves cause vibration to the surfaces within the closed room. Thus, application of the coating will reduce or eliminate the ability to monitor “conversation” within the room via the laser microphone. The laser wavelength used in these detection methods can include both the visible and NIR spectrum, however, the optimal laser wavelength is in the NIR spectrum; about 780 to 810 nanometers.

In a further embodiment, the invention includes a method of producing a liquid composition that attenuates reflection of visible and near infrared radiation. The method includes combining an absorbing agent that attenuates visible and near infrared radiation at a wavelength of about 380 nanometers to about 1400 nanometers, a carrier vehicle and a solvent system. The dyes used for the absorbing agents, the polymers used for the carrier vehicle and the solvents as well as the other additives, are the same as have been discussed herein. The dyes, or combination thereof, will define the preference for absorption of a specified wavelength based on the desired use of the composition.

The following non-limiting examples serve to further illustrate specific embodiments of the invention.

### EXAMPLE 1

A composition in accordance with the present invention was prepared by mixing the following ingredients.

| | | |
|---|---|---|
| isopropyl alcohol | 7.86 | g |
| n-propyl alcohol | 7.88 | g |
| acrylic copolymer | 66.43 | g |
| ammonia (aq) 28% | 1.984 | g |
| n-butanol | 7.96 | g |
| acetone | 3.9 | g |
| Epolite ®III-189 | 0.25 | g |
| Cyasorb ® UV-24 | 0.3 | g |
| Total Weight | 96.561 | g |

Epolite® III-189, which is a near-infrared absorbing compound, is commercially available from Epilon, Inc. of Newark, N.J.

In a beaker the isopropyl alcohol and n-propyl alcohol were combined and stirred continuously. The stirring was performed at a slow rate to avoid excess foam generation. The acrylic copolymer solution was added slowly to the mixture of alcohols. The acrylic copolymer was a water-based acrylic copolymer with a weight percent solids content of 48.8%, the remainder being water and impurities. The particular water-borne acrylic co-polymer was formed by polymerizing, in a continuous addition process various acrylic-based monomers. The approximate weight percent and type of monomers present in the copolymer were: butyl acrylate (50% by weight), methylmethacrylate (42% by weight), hydroxylethyl methacrylate (4% by weight), methacrylic acid (4% by weight) and acrylic acid (0.1% by weight). The monomers were polymerized in isopropyl alcohol for a period of about 2 hours under atmospheric pressure at a reflux temperature of about 82-84° C. 2,2′ Azobis(2-ethyl butyronitrile) was used as the catalyst.

Using a dropper, about 40% of the aqueous ammonia was added dropwise to the copolymer/alcohol mixture, at a rate of about 1-2 drops per second to raise the pH of the mixture. The n-butanol was then added to the beaker containing the copolymer/alcohol/ammonia mixture. The remainder of the aqueous ammonia was then added to the beaker to complete neutralization. In a separate beaker, Epolite® III-189 and Cyasorb® UV-24 were combined, and dissolved in acetone. The acetone solution of the Epolite® III-189 and Cyasorb® UV-24 was then added slowly during the continuous mixing to the mixture of solvent, copolymer, and ammonia to form a liquid composition which was used to form a coating on surfaces in accordance with the present invention.

Laser pulses having a wavelength of 904 nanometers were emitted from a LIDAR speed detection gun towards an uncoated automobile. The LIDAR speed detection gun detected the stationery automobile at distances of up to approximately 1300 feet. Then, using a small, normal paintbrush, the liquid composition was applied to the headlights, bumpers, license plates and reflectors of the automobile. The solvent system was removed by evaporation. The coatings had a thickness of approximately 0.75 mils. Using the same LIDAR speed detection gun, the stationary automobile was barely detectable at a distance of approximately 700 feet. The same types of comparative tests were conducted using different automobiles and are summarized below in Table I.

Automobile A was a late model, teal green, mid-size sedan with no front license plate (Dodge Intrepid). Automobile B was a 1987 silver compact with retractable headlights in the up position (Honda Accord). Automobile B′ was the same silver Honda Accord with the retractable lights in the down position. Automobile C was a late model, white, mid-size sedan with no front license plate (Chevrolet Monte Carlo).

TABLE 1

| | | Average Speed of | | Average Speed of |
|---|---|---|---|---|
| | Average Detection | Auto | Average Detection | Auto |
| | Distance - | upon detection - | Distance - | upon detection - |
| | no coating | no coating | with coating | with coating |
| Automobile | (feet) | (mph) | (feet) | (mph) |
| A | 1235 | 32.0 | 762 | 35.86 |
| A | 1108 | 77.75 | 677 | 68.0 |
| B | 1228 | 30.0 | 624.2 | 37.4 |
| B′ | 586.25 | 33.75 | 513.5 | 43.0 |
| C | 1497 | 47.5 | 1074.5 | 39.5 |

It can be seen from the results in Table 1 above that the application of a coating composition of the present invention can dramatically decrease the reflection of near infrared radiation by absorbing radiation with a wavelength of approximately 904 nm. In most instances, the maximum detection distance is reduced by about 33% to about 50% by weight after one application. Furthermore, comparison of Automobile A at high and low speeds demonstrates that higher speeds require shorter distances for detection. Also, comparison of Automobile B and B′ demonstrates that glass (headlights) play a major role in near infrared radiation reflection. While lighter paint colors such as white in the case of Automobile C reflect more near infrared radiation than darker paint colors such as teal green, the most important surfaces are the unpainted glass and metal surfaces such as headlights, bumpers, grilles, reflectors arid license plates.

### EXAMPLE 2

Using the same procedure as in Example 1, a composition in accordance with Example 1 was prepared, except that 0.50 g of Epolite® III-189 was dissolved in acetone.

### EXAMPLE 3

Using the same procedure as in Example 1, a composition in accordance with Example 1 was prepared, except that 0.75 g of Epolite® III-189 was dissolved in acetone.

### EXAMPLE 4

A composition in accordance with the present invention was prepared by mixing the following ingredients.

| | | |
|---|---|---|
| isopropyl alcohol | 27.75 | g |
| Acryloid ® B67 | 60.00 | g |
| acetone | 3.50 | g |
| Epolite ® III-189 | 0.50 | g |
| Cyasorb ® UV-24 | .25 | g |
| glycol ether | 8.00 | g |
| Total Weight | 100.00 | g |

Acryloid® B67, which is a solvent borne acrylic copolymer, is commercially available from Rohm & Haas of Philadelphia, Pa.

The alcohol, which can be mixed with n-propyl alcohol or n-butyl alcohol or a mixture of two or more of these, was placed in a beaker. The Acryloid® B67 was added slowly, while stirring, to the alcohol. The stirring was performed slowly to minimize foam formation. The acetone, Epolite® III-189, and Cyasorb® UV-24 were combined in a separate beaker and mixed until both the III-189 and UV-24 had dissolved in the acetone. The Acryloid® B67/alcohol mixture was combined with the acetone solution, and the glycol ether was added. Acryloid® B67 has a percent solids content of 45%.

### EXAMPLE 5

Using the same procedure as in Example 1, a composition in accordance with Example 1 is prepared, except that instead of using Epolite® III-189 as the NIR absorbing agent, tris (diethylaminophenyl)aminium hexafluoro-arsenate is used.

### EXAMPLE 6

Using the same procedure as in Example 2, a composition in accordance with Example 2 is prepared, except that instead of using Epolite® III-189 as the NIR absorbing agent, tris (diethylaminophenyl)aminium hexafluoroantimonate is used.

### EXAMPLE 7

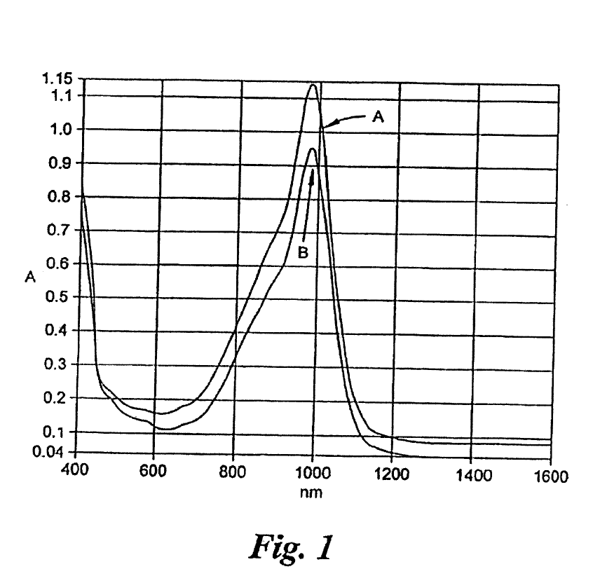

Using the same procedure as in Example 1, a composition in accordance with the present invention was prepared by mixing the following ingredients: 0.15 g of Epolite® IV-67; 25 mL of the water-borne acrylic copolymer used in Example 1; 5.0 mL of Horizon® EP solvent; 15 mL of acetone; and 0.25 g of UV-5411 (1® ultraviolet absorbing agent. Epolite® IV-67 is another near infrared absorbing compound available from Epilon, Inc., of Newark, N.J. The liquid composition was then applied to a glass slide (“Slide I”) and subjected to absorption tests at wavelengths ranging from 400 nm to 1800 nm (curve A of FIG. 1). The slide was allowed to sit in the ambient atmosphere for a period of approximately two months and was then subjected to the same absorption: tests (curve B of FIG. 1).

### EXAMPLE 8

Using the same procedure as in Example 1, a composition in accordance with Example 7 was prepared, except that instead of using Epolite® IV-67 as the NIR absorbing agent, 0.15 g of Epolite® III-184 was used. Epolite® III-184 is another near infrared absorbing compound available from Epilon, Inc., of Newark, N.J. The liquid composition was then applied to a glass slide (“Slide II”) and subjected to absorption tests at wavelengths ranging from 400 nm to 1800 nm (curve D of FIG. 1). The slide was allowed to sit in the ambient atmosphere for a period of approximately two months and was then subjected to the same absorption tests (curve C of FIG. 1).

### EXAMPLE 9

Using the same procedure as in Example 1, a composition in accordance with Example 7 was prepared, except that instead of using Epolite® IV-67 as the NIR absorbing agent, 0.15 g of Epolite® III-189 was used. The liquid composition was then applied to a glass slide (“Slide III”) and subjected to absorption tests at wavelengths ranging from 400 nm to 1800 nm (curve F of FIG. 1). The slide was allowed to sit in the ambient atmosphere for a period of approximately two months and was then subjected to the same absorption tests (curve E of FIG. 1).

### EXAMPLE 10

Using the same procedure as in Example 1, a composition in accordance with Example 7 was prepared, except that instead of using Epolite® IV-67 as the NIR absorbing agent, 0.15 g of Epolite® N-62B was used. Epolite® IV-62B is another near infrared absorbing compound available from Epilon, Inc., of Newark, N.J. The liquid composition was then applied to a glass slide (“Slide IV”) and subjected to absorption tests at wavelengths ranging from 400 nm to 1800 nm (curve G of FIG. 1). The slide was allowed to sit in the ambient atmosphere for a period of approximately two months and was then subjected to the same absorption tests (curve H of FIG. 1).

### EXAMPLE 11

Using the same procedure as in Example 1, a composition in accordance with Example 7 was prepared, except that instead of using Epolite® IV-67 as the NIR absorbing agent, 0.15 g of Epolite® III-192 was used. Epolite® III-192 is another near infrared absorbing compound available from Epilon, Inc., of Newark, N.J. The liquid composition was then applied to a glass slide (“Slide V”) and subjected to absorption tests at wavelengths ranging from 400 om to 1800 om (curve I of FIG. 1). The slide was allowed to sit in the ambient atmosphere for a period of approximately two months and was then subjected to the same absorption tests (curve J of FIG. 1).

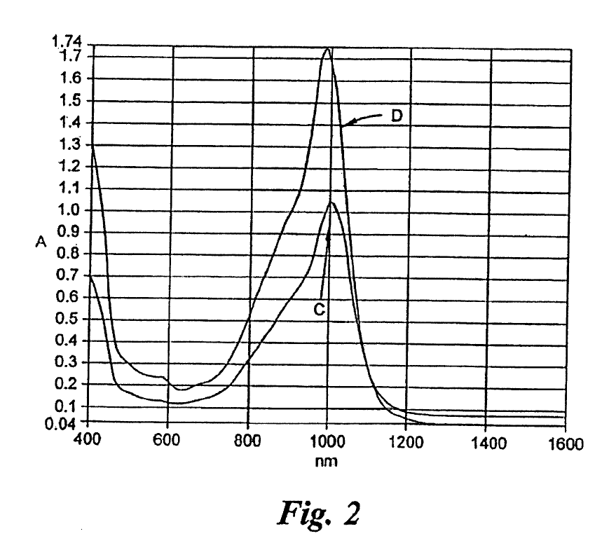

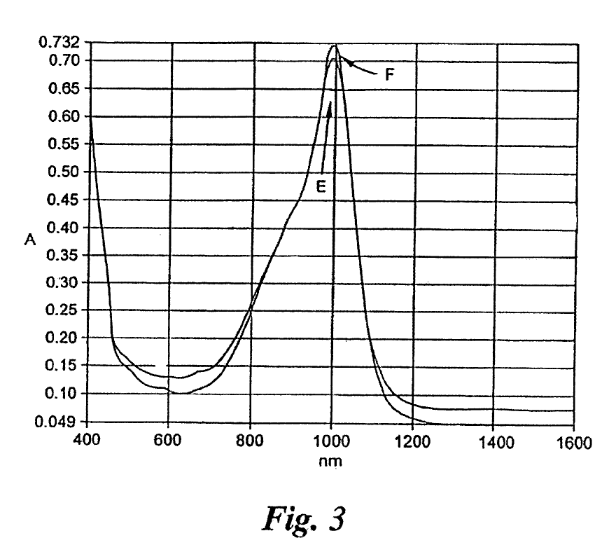

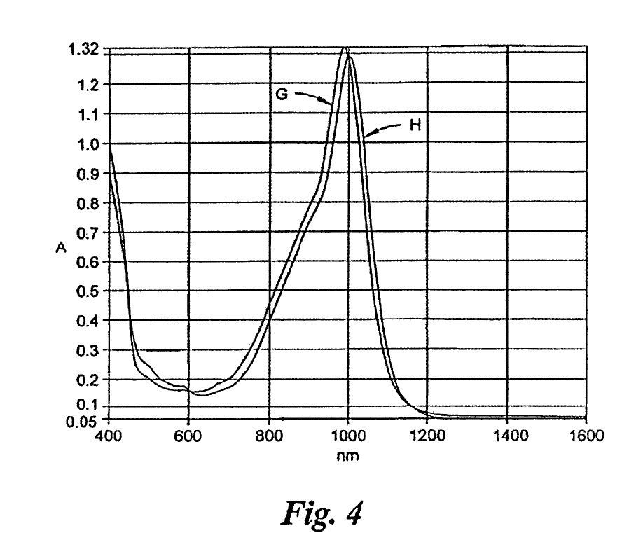

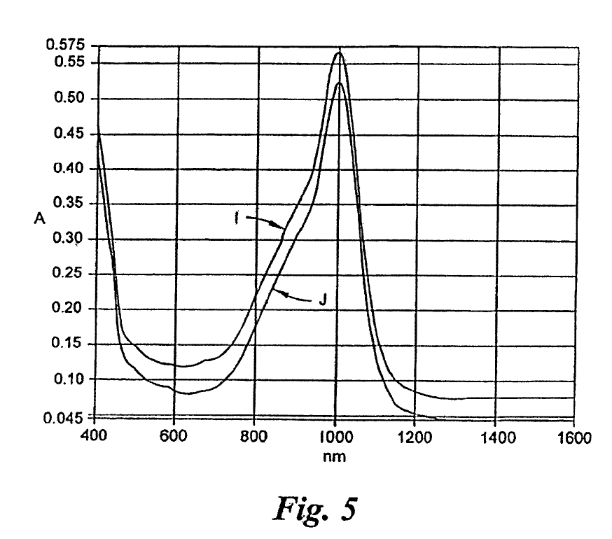

FIGS. 1-5 and Examples 7-11 demonstrate the durability and absorptivity of the coatings provided in accordance with the present invention. FIGS. 1-5 show that the liquid compositions of Examples 7-11, respectively, provide excellent transmission in the visible range (˜400 nm to ˜700 nm), while still absorbing a substantial portion of the light in the near infrared spectrum Lines A and B of FIG. 1 demonstrate that the coating obtained from the liquid composition of Example 7 absorbed only slightly less effectively after two months, evidencing the coating's durability. After taking experimental error into account with respect to measurement, the difference between absorbency over time is negligible. Lines C and D of FIG. 2 demonstrate that the coating obtained from the liquid composition of Example 8 absorbed somewhat less effectively after two months, but still absorbed a substantial amount of the near infrared light. Lines E and F of FIG. 3 demonstrate that the coating obtained from the liquid composition of Example 9, which incorporated the preferred near infrared absorbing agent, absorbed virtually the same amount of near infrared radiation and transmitted even more visible light, after two months. Lines G and H of FIG. 4 demonstrate that the coating obtained from the liquid composition of Example 10 absorbed virtually the same amount of near infrared radiation after two months, but with a slightly shifted peak absorption wavelength. Lines I and J of FIG. 5 demonstrate that the coating obtained from the liquid composition of Example 11 absorbed only slightly less effectively after two months.

### EXAMPLE 12

Glass slide A was prepared by twice dipping the slide into the liquid coating composition prepared in accordance with Example 1, and subsequently removing the slide and allowing it to air dry. The slide was allowed to air dry for several hours, until the solvent had evaporated and a hard, uniform coating with a thickness of approximately 0.75 mils remained. The slide was then subjected to absorption and transmission testing. The results are summarized below in Table 2.

### EXAMPLE 13

Glass slide B was prepared by twice dipping the slide into the liquid coating composition of Example 2 and subsequently removing the slide and allowing it to air dry. The slide was allowed to air dry for several hours, until the solvent had evaporated and a hard, uniform coating with a thickness of 0.60 mils remained. The slide was then subjected to absorption and transmission testing. The results are summarized below in Table 2.

### EXAMPLE 14

Glass slide C was prepared by twice dipping the slide into the liquid coating compositions of Example 3 and subsequently removing the slide and allowing it to air dry. The slide was allowed to air dry for several hours, until the solvent had evaporated and a hard, uniform coating with a thickness of 0.75 mils remained. The slide was then subjected to absorption and transmission testing. The results are summarized below in Table 2.

TABLE 2

| | Coating Thickness | Absorbance | Transmittance in |
|---|---|---|---|
| | (mils) | at | Visible Range |
| Slide | approx. | 904 nm (%) | 400-700 nm (%) |
| A | 0.75 | 99.0 | 84.7 |
| B | 0.60 | 99.9 | 78.4 |
| C | 0.75 | 99.9 | 74.7 |

The data in Table 2 demonstrates that suitable absorbance can be obtained with small amounts of near infrared absorbing compound. Furthermore, adequate absorbency can be obtained without sacrificing transmission of visible light at fairly low concentrations. Thus, it is possible to use the liquid compositions of the present invention to coat large transparent (glass) objects so as to reduce the reflection and transmission of near infrared radiation, without significantly affecting the transparency of the object.

### EXAMPLE 15

A composition in accordance with the present invention was prepared by mixing the following ingredients.

| | | |
|---|---|---|
| acrylic copolymer | 63.49 | g |
| Epolite ® III - 189 | 0.45 | g |
| acetone | 17.84 | g |
| Horizon ® EP | 9.01 | g |
| Cyasorb ® UV-5411 | 2.7 | g |
| propylene glycol methyl ether | 6.52 | g |
| Dow Corning ® 2-6040 Silane | 0.09 | g |
| Total weight | 100.1 | g |

Horizon® EP solvent is commercially available from Inland Technology, Inc., Tacoma, Wash. Cyasorb® UV-5411, which is an infrared absorbing agent, is commercially available from Cytec Industries, Inc. of West Patterson, N.J.

The propylene glycol methyl ether was placed in a beaker to which the acrylic copolymer was added. The acrylic copolymer was a water-based acrylic copolymer with a weight percent solid content of about 49.5%, the remainder being solvent and impurities. The approximate weight percent and type of monomer present in the copolymer were: methylmethacrylate (50% by weight), ethylacrylate (20% by weight) and dimethylaminoethylmetacrylate (30% by weight). The monomers were polymerized in isopropanol for a period of about 2 hours under atmospheric pressure at a reflux temperature of about 83° C. Butene nitrile, 2 methyl, 2,2 azo-bis was used as a catalyst.

In a separate beaker, Horizon® EP, Epolite® I11-189 and Cyasorb® UV-5411 were combined by dissolving in acetone. This mixture was added slowly during continuous mixing to the mixture of copolymer and solvent to form the liquid composition for coating surfaces in accordance with the present invention.

### EXAMPLE 16

Using the procedure of Example 15, a composition in accordance with the present invention was prepared by mixing the following ingredients.

| | | |
|---|---|---|
| Horizon ® EP | 8.24 | g |
| acetone | 14.58 | g |
| Cyasorb ® UV-5411 | 2.21 | g |
| propylene glycol methyl ether | 5.07 | g |
| acrylic copolymer | 51.89 | g |
| Epolite ® III-189 | .23 | g |
| propylene glycol methyl ether acetate | 17.78 | g |
| Total weight | 100.00 | g |

The acrylic copolymer was a water-based copolymer with a percent solids content of 49.5%, the remainder being solvent and impurities. The approximate weight percent and type of monomer present in the copolymer were: methylmethacrylate (55% by weight), ethylacrylate (15% by weight), and dimethylaminoethylmetacrylate (30% by weight).

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

I claim:

1. A liquid composition for coating surfaces comprising:
(a) an absorbing agent which attenuates electromagnetic radiation in the visible and/or near infrared wavelength ranges;
(b) a carrier vehicle, wherein the carrier vehicle comprises a polymer selected from the group consisting of a copolymer having at least butyl acrylate, methylmethacrylate and hydroxyethylmethacrylate as monomers or a copolymer having at least methylmethacrylate, ethylacrylate and dimethylaminoethylmethacrylate as monomers; and
(c) a solvent system,
wherein the absorbing agent comprises dyes derived from the following chromophore groups: acridine, anthraquinone, diphenyl methane, triphenyl methane, azo structure, diazonium salts, a nitro functional group, nitroso functional group, phthalocyanine, quinone, safranin, indamins, indophenol, oxazin, oxazone, thiazin, thiazole, xanthene, fluorene, rhodamine and fluorone.

2. The liquid composition of claim 1, comprising about 0.1% to about 2% by weight of the absorbing agent, about 30% by weight to about 45% by weight of the carrier vehicle; and about 55% by weight to about 70% by weight of the solvent system, each based upon the total weight of the composition.

3. The liquid composition for coating surfaces of claim 2, further comprising one or more organofunctional silane additive(s) selected from the group consisting of aminofunctional silanes, epoxyfunctional silanes and vinyl functional silanes, wherein the one or more organofunctional silane additive(s) are present in the amount of about 0.01% to about 2% by weight of the liquid composition.

4. The liquid composition for coating surfaces of claim 2, wherein the carrier vehicle comprises a water-borne carboxyl and hydroxyl functional acrylic copolymer, wherein the water-borne carboxyl and hydroxyl functional acrylic copolymer has an acid number of about 10 to about 50, a hydroxyl number of about 20 to about 50, and a molecular weight of about 20,000 to about 40,000.

5. The liquid composition for coating surfaces of claim 1, wherein the carrier vehicle comprises a copolymer formed by polymerization of monomers comprising: (a) about 45% to about 55% by weight butyl acrylate, (b) about 38% to about 45% by weight methylmethacrylate, (c) about 4% to about 10% by weight hydroxyethylmethacrylate, (d) about 0% to about 8% by weight methacrylic acid, and (e) about 0% to about 2% by weight acrylic acid.

6. The liquid composition for coating surfaces of claim 1, wherein the carrier vehicle comprises a copolymer formed by the polymerization of monomers comprising: (a) about 40% to about 70% by weight methylmethacrylate, (b) about 10% to about 30% by weight ethylacrylate, (c) about 20% to about 30% by weight dimethylaminoethylmethacrylate.

7. The liquid composition for coating surfaces of claim 2, wherein the solvent system comprises a ketone, wherein the ketone is selected from the group consisting of acetone, and methylethylketone.

8. The liquid composition for coating surfaces of claim 7, wherein the solvent system further comprises at least one component selected from the group consisting of alcohols, terpenes, and glycol ethers.

9. The liquid composition for coating surfaces of claim 2, further comprising one or more additives selected from the group consisting of ultraviolet absorbers, flatting agents, slip agents, and pH modifiers.

10. The liquid composition of claim 2, wherein the liquid composition has a thickness of about 0.25 mil to about 2 mil, wherein the thickness is measured in a direction transverse to the surface.

11. A method of attenuating the reflection of electromagnetic radiation from a surface comprising:
(a) applying a liquid composition comprising an absorbing agent which attenuates electromagnetic radiation in the visible and/or near infrared wavelength ranges, a carrier vehicle and a solvent system to a surface; and
(b) removing the solvent system after application of the composition to a surface.

12. The method of claim 11 wherein the wherein the absorbing agent comprises dyes derived from the following chromophore groups: acridine, anthraquinone, diphenyl methane, triphenyl methane, azo structure, diazonium salts, a nitro functional group, nitroso functional group, phthalocyanine, quinone, safranin indamins, indophenol, oxazin, oxazone, thiazin, thiazole, xanthene, fluorene, rhodamine and fluorone,
wherein the carrier vehicle comprises a polymer selected from the group consisting of a copolymer having at least butyl acrylate, methylmethacrylate and hydroxyethylmethacrylate as monomers or a copolymer having at least methylmethacrylate, ethylacrylate and dimethylaminoethylmethacrylate as monomers.

13. A system for detecting an object comprising:
(a) an object having a composition disposed thereon, wherein the composition attenuates near infrared radiation at a wavelength of about 750 to about 1100 nanometers; and
(b) a detecting device which detects near infrared radiation at a wavelength of about 750 to about 1100 nanometers.

14. The system according to claim 13, wherein the composition includes a near infrared absorbing agent, a carrier vehicle and a solvent system, wherein the carrier comprises a polymer selected from the group consisting of a copolymer having at least butyl acrylate, methylmethacrylate and hydroxyethylmethacrylate as monomers or a copolymer having at least methylmethacrylate, ethylacrylate and dimethylaminoethylmethacrylate as monomers, wherein the near infrared absorbing agent comprises dyes derived from the following chromophore groups: acridine, anthraquinone, diphenyl methane, triphenyl methane, azo structure, phthalocyanine, diazonium salts, a nitro functional group, nitroso functional group, phthalocyanine, quinone, safranin, indamins, indophenol, oxazin, oxazone, thiazin, thiazole, xanthene, fluorene, rhodamine and fluorone.

15. The system of claim 14, wherein the coating has a thickness of about 0.7 millimeters.

16. The system of claim 14, wherein the detection device is a light distance and ranging gun emitting a wavelength of about 904 nanometers.

17. The system of claim 16, wherein the object is a vehicle.

18. The system of claim 17, wherein the composition is applied to the glass and metal surfaces of the vehicle.

19. The system of claim 18, wherein the distance of detection by the detection device was decreased by at least 20% compared to an object that did not have the composition applied thereto.

20. A detector assembly for creating a scanner signal in response to light reflected from a scan pattern by a bar code, the scan pattern consisting of light having a defined wavelength, comprising:
(a) a light sensitive detector operative to generate a signal in response to light striking the detector, and
(b) a coating on a portion of the light sensitive detector, the coating comprises an absorbing agent which attenuates reflection of electromagnetic radiation, a carrier vehicle, and a solvent system.

21. The method of claim 20, wherein the absorbing agent comprises dyes derived from the following chromophore groups: acridine, anthraquinone, diphenyl methane, triphenyl methane, azo structure, phthalocyanine, diazonium salts, a nitro functional group, nitroso functional group, quinone, safranin, indamins, indophenol, oxazin, oxazone, thiazin, thiazole, xanthene, fluorene, rhodamine, fluorone, compounds of the formula (I):
[(R₂NZ)₂N═Z′═NR₂]²⁺⁺²X⁻ (I)
wherein R is an alkyl group of about 1 to about 6 carbon atoms; Z is a divalent phenyl which may or may not be ring substituted with one or more alkyl, alkoxy, halogen, nitro, cyano, and carboalkoxy groups; Z′ is a quinoidal phenyl which may or may not be ring substituted with one or more alkyl, alkoxy, halogen, nitro, cyano, and carboalkoxy groups; and X is an anion of a strong acid, and
compounds of the formula (II):
[(R₂NZ)₃N]⁺+X⁻ (II)
wherein R is an alkyl group of about 1 to about 6 carbon atoms; Z is a divalent phenyl which may or may not be ring substituted with one or more alkyl, alkoxy, halogen, nitro, cyano, and carboalkoxy groups; and X is an anion of a strong acid and derivatives and combinations thereof,
wherein the carrier vehicle comprises a polymer selected from the group consisting of a copolymer having at least butyl acrylate, methylmethacrylate and hydroxyethylmethacrylate as monomers or a copolymer having at least methylmethacrylate, ethylacrylate and dimethylaminoethylmethacrylate as monomers.

22. The detector assembly according to claim 21, wherein the detector senses incident light strike having a wavelength of about 600 nanometers to about 700 nanometers.

23. The detector assembly according to claim 22, wherein the light sensitive detector includes a lens element integral thereto to focus light onto the detector.

24. The detector assembly according to claim 23, wherein the coating is on the lens element of the detector.

25. A tape to attenuate reflection of electromagnetic radiation from a detector, the tape comprising a first side having a coating thereon which attenuates visible and near-infrared radiation and a second side for adhering to a surface.

26. The tape of claim 25, wherein the coating comprises:
(a) an absorbing agent which attenuates reflection of visible and near infrared radiation having a wavelength of about 500 nanometers to about 1100 nanometers,
(b) a carrier vehicle; and
(c) a solvent system,
wherein the wherein the absorbing agent comprises dyes derived from the following chromophore groups: acridine, anthraquinone, diphenyl methane, triphenyl methane, azo structure, phthalocyanine, diazonium salts, a nitro functional group, nitroso functional group, quinone, safranin, indamins, indophenol, oxazin, oxazone, thiazin, thiazole, xanthene, fluorene, rhodamine, fluorone, compounds of the formula (I):
[(R₂NZ)₂N═Z′═NR₂]²⁺+2X⁻ (I)
wherein R is an alkyl group of about 1 to about 6 carbon atoms; Z is a divalent phenyl which may or may not be ring substituted with one or more alkyl, alkoxy, halogen, nitro, cyano, and carboalkoxy groups; Z′ is a quinoidal phenyl which may or may not be ring substituted with one or more alkyl, alkoxy, halogen, nitro, cyano, and carboalkoxy groups; and X is an anion of a strong acid, and
compounds of the formula (II):
[(R₂NZ)₃N]⁺+X⁻ (II)
wherein R is an alkyl group of about 1 to about 6 carbon atoms; Z is a divalent phenyl which may or may not be ring substituted with one or more alkyl, alkoxy, halogen, nitro, cyano, and carboalkoxy groups; and X is an anion of a strong acid and derivatives and combinations thereof,
wherein the carrier vehicle comprises a polymer selected from the group consisting of a copolymer having at least butyl acrylate, methylmethacrylate and hydroxyethylmethacrylate as monomers or a copolymer having at least methylmethacrylate, ethylacrylate and dimethylaminoethylmethacrylate as monomers.

27. A tape as claimed in claim 26, in which the coating has thickness in the amount of about 6.0 to about 40 mils.

28. A method to attenuate the detection of sound within a closed room by a laser microphone comprising:
(a) applying a coating to a surface within the closed room which will vibrate upon contact with sound waves, wherein the coating comprises an absorbing agent which attenuates reflection of radiation having a wavelength of about 500 nanometers to about 1100 nanometers, a carrier vehicle and a solvent system, and
(b) subjecting the closed room to sound waves such that the sound waves cause vibration of the surface within the closed room which will vibrate upon contact with sound waves.

29. The method of claim 28 wherein the wherein the absorbing agent comprises dyes derived from the following chromophore groups: acridine, anthraquinone, diphenyl methane, triphenyl methane, azo structure, diazonium salts, a nitro functional group, nitroso functional group, phthalocyanine, quinone, safranin, indamins, indophenol, oxazin, oxazone, thiazin, thiazole, xanthene, fluorene, rhodamine, fluorone, compounds of the formula (I):
[(R₂NZ)₂N↑Z′=NR₂]²⁺+2X⁻ (I)
wherein R is an alkyl group of about 1 to about 6 carbon atoms; Z is a divalent phenyl which may or may not be ring substituted with one or more alkyl, alkoxy, halogen, nitro, cyano, and carboalkoxy groups; Z′ is a quinoidal phenyl which may or may not be ring substituted with one or more alkyl, alkoxy, halogen, nitro, cyano, and carboalkoxy groups; and X is an anion of a strong acid, and
compounds of the formula (II):
[(R₂NZ)₃N]⁺+X⁻ (II)
wherein R is an alkyl group of about 1 to about 6 carbon atoms; Z is a divalent phenyl which may or may not be ring substituted with one or more alkyl, alkoxy, halogen, nitro, cyano, and carboalkoxy groups; and X is an anion of a strong acid and derivatives and combinations thereof,
wherein the carrier vehicle comprises a polymer selected from the group consisting of a copolymer having at least butyl acrylate, methylmethacrylate and hydroxyethylmethacrylate as monomers or a copolymer having at least methylmethacrylate, ethylacrylate and dimethylaminoethylmethacrylate as monomers.

30. A method of producing a liquid composition that attenuates reflection of visible and/or near infrared radiation comprising:
combining an absorbing agent that attenuates visible and/or near infrared radiation at a wavelength of about 380 nanometers to about 1400 nanometers, a carrier vehicle and a solvent system.

31. The method of claim 30 wherein the wherein the absorbing agent comprises dyes derived from the following chromophore groups: acridine, anthraquinone, diphenyl methane, triphenyl methane, azo structure, phthalocyanine, diazonium salts, a nitro functional group, nitroso functional group, quinone, safranin, indamins, indophenol, oxazin, oxazone, thiazin, thiazole, xanthene, fluorene, rhodamine and fluorone,
wherein the carrier vehicle comprises a polymer selected from the group consisting of a copolymer having at least butyl acrylate, methylmethacrylate and hydroxyethylmethacrylate as monomers or a copolymer having at least methylmethacrylate, ethylacrylate and dimethylaminoethylmethacrylate as monomers.
